(19) United States
(12) Patent Application Publication
(10) Pub. No.: US 2019/0214723 A1
(43) Pub. Date: Jul. 11, 2019

(54) BEAM-STEERABLE ANTENNA DEVICES, SYSTEMS, AND METHODS

(71) Applicant: wiSpry, Inc., Irvine, CA (US)

(72) Inventors: Shuai Zhang, Aalborg SV (DK); Igor Syrytsin, Aalborg (DK); Gert Frølund Pedersen, Storvorde (DK)

(21) Appl. No.: 16/240,698

(22) Filed: Jan. 4, 2019

Related U.S. Application Data
(60) Provisional application No. 62/614,083, filed on Jan. 5, 2018.

(51) Int. Cl. H01Q 3/24; H01Q 21/06; H01Q 5/335; H01Q 5/378

(52) U.S. Cl. CPC H01Q 3/24; H01Q 5/378; H01Q 5/335; H01Q 21/061

(57) ABSTRACT

Devices, systems, and methods for a compact beam-steerable antenna array for centimeter-wave and millimeter-wave mobile terminals, the antenna array having a steerable beam without phase shifters. In some embodiments, an antenna array includes an active antenna element and at least one parasitic element spaced apart from the active antenna element. An impedance between each of the at least one parasitic element and a ground element is tunable to steer a signal beam at the active antenna element in a desired direction.

### CROSS-REFERENCE TO RELATED APPLICATION

The present application claims priority to U.S. Provisional Patent Application Ser. No. 62/614,083, filed Jan. 5, 2018, the entire disclosure of which is incorporated by reference herein.

### TECHNICAL FIELD

The subject matter disclosed herein relates generally to mobile antenna systems and devices. More particularly, the subject matter disclosed herein relates to centimeter-wave and millimeter-wave mobile terminals and other mobile devices.

### BACKGROUND

The fifth generation mobile communications network, also known as 5G, is expected to operate in several frequency ranges, including 3-30 GHz and even beyond 30 GHz. The 3-30 GHz band is known as the centimeter-wave band and the 30-300 GHz band is known as the millimeter-wave band. Using these frequency bands, 5G mobile communications networks are expected to provide significant improvements in data transmission rates, reliability, and delay, as compared to the current fourth generation (4G) communications network Long Term Evolution (LTE).

At centimeter-wave (cm-wave) and millimeter-wave (mm-wave) frequencies, beam steerable antenna arrays with high gain have to be applied at both transmitting and receiving ends. Conventionally, the beam steerable array is realized by changing the phase of each element with phase shifters and feeding networks. However, in cm-wave and mm-wave bands, phase shifters and feeding networks are very lossy, which increases the power consumption of the beam steerable antenna system. This problem highly limits the application of cm-wave and mm-wave in mobile terminals due to the short battery life of the mobile terminals.

### SUMMARY

In accordance with this disclosure, devices, systems, and methods for producing a beam-steerable antenna are provided. In one aspect, a beam-steerable antenna includes a first parasitic element, a second parasitic element spaced apart from the first parasitic element, and an active antenna element positioned between the first parasitic element and the second parasitic element. A first impedance between the first parasitic element and a ground element and a second impedance between the second parasitic element and the ground element are each independently tunable, and the first impedance and the second impedance are tunable to steer a signal beam at the active antenna element in a desired direction.

Some advantages offered by the subject matter disclosed herein include beam steering without phase shifters and complicated feeding networks for phase shifters. In turn the subject matter disclosed herein below is simpler and more cost effective than previous methods. Furthermore, the subject matter disclosed herein has a compact configuration which can be flexible and placed at a vacant area of a crowded environment inside mobile terminals. The term flexible in this context means that there is no requirement that an array be located in any specific location around a phone chassis. The array can be placed in many places around the phone chassis according to the practical scenarios involved. Moreover, it is possible to integrate an antenna array, switch, and a loaded short and/or open transmission together into a package.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1 illustrates a perspective top view of a beam-steerable antenna system provided on a mobile device according to an embodiment of the presently disclosed subject matter;

FIG. 2 illustrates a schematic circuit diagram of a beam-steerable antenna system according to an embodiment of the presently disclosed subject matter;

FIG. 3 illustrates a perspective top view of a beam-steerable antenna system according to an embodiment of the presently disclosed subject matter;

FIG. 4 illustrates a plan view of a beam-steerable antenna system according to an embodiment of the presently disclosed subject matter;

FIG. 5 illustrates a schematic representation of a switch used to adjust an impedance of a parasitic element of a beam-steerable antenna system according to an embodiment of the presently disclosed subject matter;

FIG. 6 illustrates a plan view of a beam-steerable antenna system according to an embodiment of the presently disclosed subject matter;

FIGS. 7A-7D are graphs illustrating radiation patterns of a beam-steerable antenna at various impedance settings of the parasitic elements system according to an embodiment of the presently disclosed subject matter;

FIGS. 8A-8G are graphs illustrating radiation patterns of a beam-steerable antenna at various impedance settings of the parasitic elements system according to an embodiment of the presently disclosed subject matter;

FIG. 9 is a graph illustrating a realized gain within an operating band of a beam-steerable antenna system according to an embodiment of the presently disclosed subject matter; and

FIG. 10 is a graph illustrating the S-parameters of a beam-steerable antenna system according to an embodiment of the presently disclosed subject matter.

### DETAILED DESCRIPTION

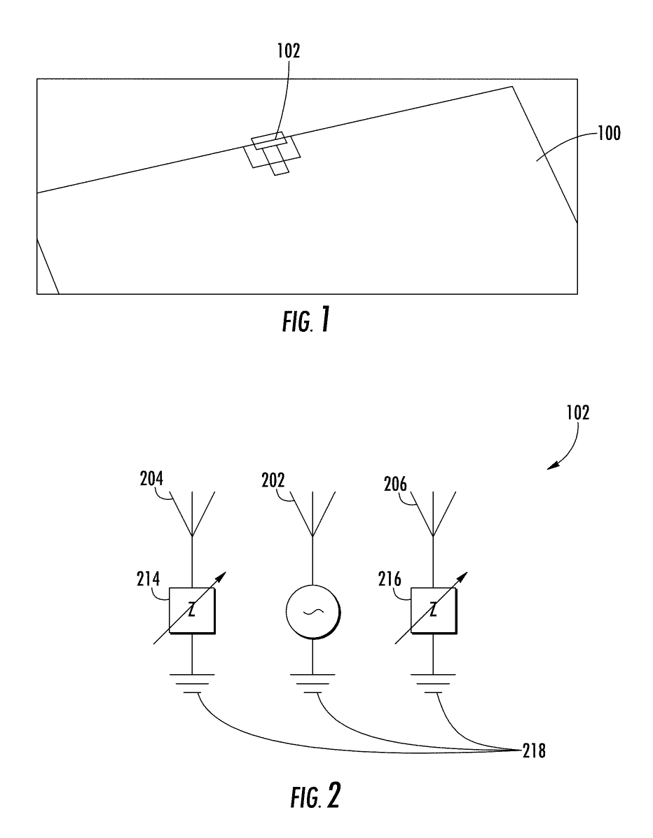

The present subject matter provides a compact, beam-steerable antenna array without a phase shifter for centimeter-wave and millimeter-wave mobile terminals. FIG. 1 of the present disclosure illustrates a perspective top view of a beam-steerable antenna system 102 provided on a mobile device 100 according to an embodiment of the presently disclosed subject matter. In some embodiments, the width of the mobile device 100 is half its length. In some embodiments, for example without limitation, the mobile device 100 is about 150 mm long and about 75 mm wide. In some embodiments, the beam-steerable antenna system 102 is positioned, for example without limitation, on a side of the mobile device 100 approximately halfway between each end of the mobile device 100. In some other embodiments, the beam-steerable antenna system 102 is positioned on either side of the mobile device 100 and is positioned anywhere along either side of the mobile device 100. In some embodiments, the mobile device 100 is a 5G mobile terminal. In some embodiments, the mobile device 100 is a mobile device or other wireless communication device. In some embodiments the beam-steerable antenna system 102 is positioned closer to an edge of the mobile device 100 and not as close to the center of the side of the mobile device 100.

In one aspect, the present subject matter provides an antenna system in which there is one active antenna element 202 and at least one passive parasitic element or passive monopole. For example, in the configuration shown in FIG. 2, the beam-steerable antenna system 102 can include a first parasitic element 204, a second parasitic element 206 spaced apart from the first parasitic element 204, and the active antenna element 202 positioned between the first parasitic element 204 and the second parasitic element 206. In some embodiments, for example without limitation, the beam-steerable antenna system 102 can comprise three parasitic elements or more. In some embodiments, for example without limitation, the inter-element distance of the array can be less than half of the wavelength of electromagnetic waves propagated by the beam-steerable antenna system 102. For example without limitation, in some embodiments, the active and passive elements can be spaced apart with respect to one another by between about 3 mm to 4 mm. In this arrangement, the passive monopoles can provide enough scattered energy to superpose with the radiation of the active monopole. In some embodiments, the first parasitic element 204 and the second parasitic element 206 are passive monopoles.

Although the embodiments illustrated in FIGS. 2 and 3, and described herein, includes two parasitic elements, first parasitic element 204 and second parasitic element 206, other embodiments of the present subject matter can include one parasitic element or more than two parasitic elements. Furthermore, the inter-element spacing between each of the first parasitic element 204, the second parasitic element 206, and the active antenna element 202 can be designed to be substantially similar (for example without limitation, all parasitic elements can be spaced substantially the same distance from the active antenna element 202) or different (for example without limitation, one or more element positioned closer to the active antenna element 202 than others). In some embodiments, for example without limitation, the inter-element spacing between each of the first parasitic element 204, the second parasitic element 206, and the active antenna element 202 can be between about 3 mm and about 4 mm. In some embodiments, for example without limitation, the inter-element spacing between each of the first parasitic element 204, the second parasitic element 206, and the active antenna element 202 can be between about 3.25 mm and about 3.75 mm. In any arrangement, by changing the impedance to one or more parasitic elements (e.g., at or near an end of each parasitic element that is proximal to a ground element 218), the impedance between the parasitic elements and the ground element 218 (e.g., a ground plane) effectively becomes either more inductive or more capacitive. In this way, one or more of the parasitic elements can work as a reflector and/or a director where the impedance to the parasitic elements is primarily inductive or primarily capacitive, respectively, to steer a signal beam at the active antenna element in a desired direction.

Depending on the number of parasitic elements and/or their arrangement about the active antenna element 202, the precision with which the direction of the signal beam can be steered can be varied. For example without limitation, configurations incorporating more parasitic elements may be able to provide greater control over the beam steering. Alternatively or in addition, spacing the first parasitic element 204 and second parasitic element 206 from the active antenna element 202 in different directions can provide additional degrees of freedom in the directions to which the beam can be steered. In some embodiments, for instance, the first parasitic element 204, the second parasitic element 206, and the active antenna element 202 can be arranged in a substantially collinear and/or co-planar array to enable the beam to be steered substantially within the plane. Alternatively, in other embodiments in which the first parasitic element 204, the second parasitic element 206, and the active antenna element 202 are not all arranged in a single plane, the range of beam angles can be further varied such that the beam is steerable in three dimensions.

In some embodiments, the first parasitic element 204, the second parasitic element 206, and the active antenna element 202 are all connected to a ground element 218. In some embodiments, a first impedance between the first parasitic element 204 and the ground element 218 and a second impedance between the second parasitic element 206 and the ground element 218 are each independently tunable. In some embodiments, one or more parasitic elements can be connected to one or more impedance elements. For example and without limitation, in some embodiments, the first parasitic element 204 is connected to a first impedance element 214 and the second parasitic element 206 is connected to a second impedance element 216. In some embodiments, adjusting an impedance of the first impedance element 214 tunes the first impedance between the first parasitic element 204 and the ground element 218. In some embodiments, adjusting an impedance of the second impedance element 216 tunes the second impedance between the second parasitic element 206 and the ground element 218. In some embodiments, one or more impedance element comprises one or more tunable element. For example without limitation, in some embodiments, one or both of the first impedance element 214 or the second impedance element 216 comprises one or more tunable element. Moreover, in some embodiments, one or more impedance elements comprises one or more fixed inductors or one or more fixed capacitors. For example, without limitation, one or both of the first impedance element 214 or the second impedance element 216 comprises one or more fixed inductors or one or more fixed capacitors.

FIG. 3 illustrates a perspective top view of the beam-steerable antenna system 102 according to an embodiment of the presently disclosed subject matter. This view also illustrates the first parasitic element 204, the active antenna element 202, the second parasitic element 206, and how each of the elements is positioned about the mobile device 100. Those of ordinary skill in the art will appreciate that in some embodiments, the beam-steerable antenna system 102 can comprise a third parasitic element 208, a fourth parasitic element 210, or even more. Third parasitic element 208 and fourth parasitic element 210 are dashed to indicate that more than two parasitic elements can be included but are not necessarily discussed in detail in the remainder of the discussion for FIG. 3. Those of ordinary skill in the art will recognize that the principles discussed herein with respect to the first parasitic element 204 and the second parasitic element 206 can also be applied to a possible third parasitic element 208 or a possible fourth parasitic element 210. Furthermore, in some embodiments, the beam-steerable antenna system 102 can comprise only a single parasitic element, which is not shows, but those of ordinary skill in the art would appreciate visualizing FIG. 3 with only one of the parasitic elements present. In some embodiments, the beam-steerable antenna system 102 comprises a housing 300. In some embodiments, for example without limitation, the housing 300 is rectangular in shape and has a length of about 8.5 mm, a width of about 3 mm, and a height of about 2.5 mm. In some embodiments, the housing can be of any other suitable shape and size to house the components of the antenna system 102.

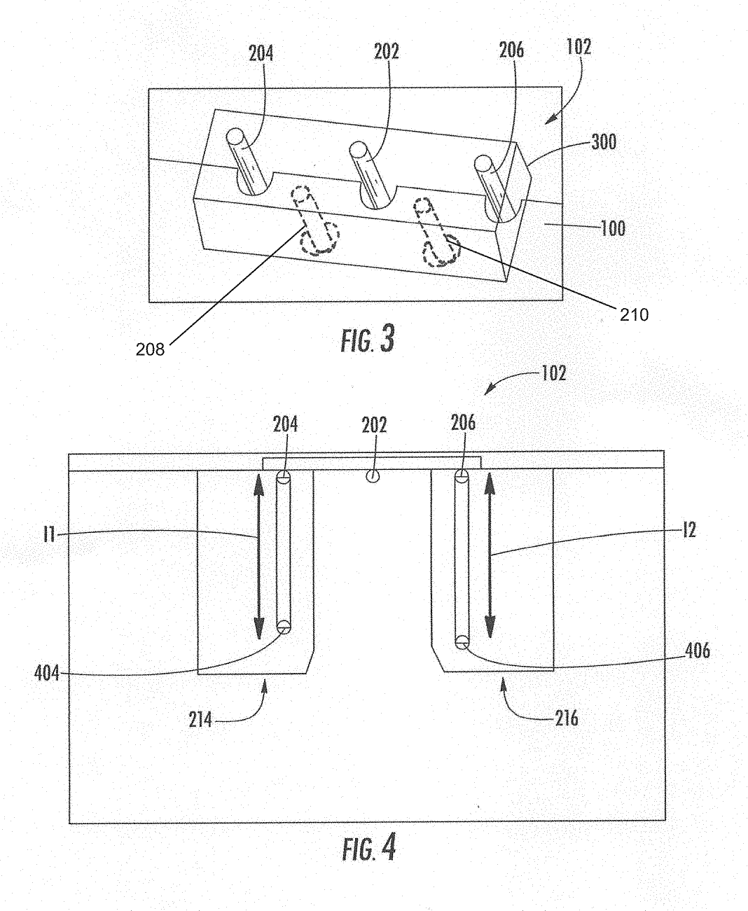

In some embodiments, whereas the active antenna element 202 can be fed to a transmitter and/or receiver on the mobile device 100 (for example without limitation via a coaxial cable to a substrate-integrated waveguide transition), the impedance to one or more of the parasitic elements can be realized by a transmission line with a first end (for example without limitation, an end proximal to the ground plane) shorted or open, such as that illustrated by the antenna system 102 in FIG. 4. Furthermore, in some embodiments, the transmission line can comprise a second end that is connected to a respective parasitic element. FIG. 4 illustrates the active antenna element 202, the first parasitic element 204, and the second parasitic element 206. Further, in some embodiments, to enable a change in the impedance, the first parasitic element 204 and the second parasitic element 206 can be connected to one or more transmission line elements by a switch (for example and without limitation, a MEMS or silicon on insulator (SOI) multi-throw switch) with one input and N outputs, where the one or more different transmission line elements have different lengths. Those of ordinary skill in the art will appreciate that the one or more transmission line elements can act as the first impedance element 214 and the second impedance element 216. In some embodiments, the one or more transmission line elements can have different lengths, each length of transmission line having a different impedance. In this regard, the impedance between the two parasitic elements and ground can be tuned based on the impedance of the different size transmission lines.

As illustrated in FIG. 4, first parasitic element 204 is connected to first transmission line element 404 and second parasitic element 206 is connected to second transmission line element 406. In some embodiments, first transmission line element 404 has a first effective length l1 and the second transmission line element 406 has a second effective length l2. In some embodiments, the first effective length l1 and the second effective length l2 can be adjusted to correspondingly adjust the impedance of the first parasitic element 204 and the second parasitic element 206, respectively.

In some embodiments, each at least one parasitic element is connected to one or more impedance elements. In some embodiments, one or more impedance element comprises at least one transmission line element having a first end that is shorted or open and a second end connected to at least one parasitic element. In some embodiments, one or more of the one or more impedance element comprises a plurality of transmission line elements having different lengths, wherein each of the plurality of transmission line elements has a first end that is shorted or open and a second end that is selectively connected to the at least one parasitic element by a switch.

In one embodiment illustrated in FIG. 5, for example and without limitation, N=4 such that both the first parasitic element 204 and the second parasitic element 206 have 5 states. In some embodiments, one or both of the first impedance element 214 or the second impedance element 216 comprises a plurality of transmission line elements having different lengths, wherein each of the plurality of transmission line elements has a first end that is shorted or open and a second end that is selectively connected to a respective one of the first parasitic element 204 or the second parasitic element 206. The insertion loss of a 1:4 switch 500 is around 2.5 dB at 28 GHz. Since the switch 500 is connected to passive elements, the total loss of efficiency in the whole antenna system 102 is less than 2 dB. In some embodiments, the switch 500 is a 1-input and 4-output (1P4T) reflective switch that can be used for each passive monopole/parasitic element. In some embodiments, the four outputs of the switch can be connected to four short-circuited transmission lines, giving the first four states, and the last reactive impedance can be realized by opening all the four outputs, giving the last and fifth state.

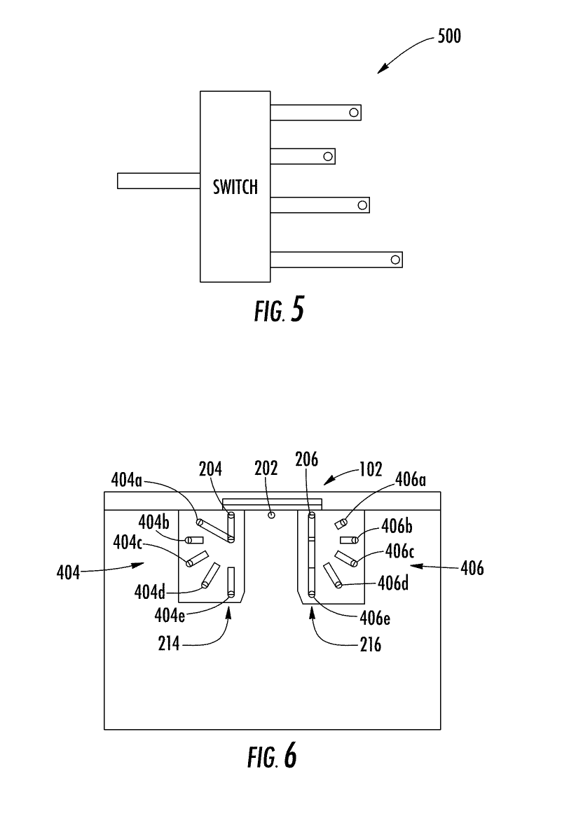

FIG. 6 illustrates another embodiment of an the antenna system 102 in which first parasitic element 204 and second parasitic element 206 are switchable among five states to alter the lengths of first transmission line element 404 and second transmission line element 406. As illustrated in FIG. 6, the first transmission line element 404 acts as the first impedance element 214 and the second transmission line element 406 acts as the second impedance element 216. With help from the switch 500 (not shown in this view), the first transmission line element 404 can be several different lengths based on which of the five states it is connected to. In some embodiments, the first transmission line element 404 can be connected in a first state 404a, a second state 404b, a third state 404c, a fourth state 404d, or a fifth state 404e. In some embodiments, the second transmission line element 406 can also be connected in a first state 406a, a second state 406b, a third state 406c, a fourth state 406d, and a fifth state 406e. In any configuration, it is also possible to integrate the switch and short transmission line into one small package. Those having ordinary skill in the art will recognize that other kinds of impedance tuning known in the art could also be effective in adjusting the impedance to the parasitic elements. For example without limitation, in some embodiments, this impedance tuning can be effected using one or more of a solid-state varactor, an SOI capacitive tuner, a MEMS capacitive tuner, an inductor, or a MEMS impedance tuner, although configurations that include inductors and/or capacitors can introduce high losses when operated over 20 GHz. Furthermore, combinations of such tuning elements with a shorted or open transmission line are contemplated by the present subject matter.

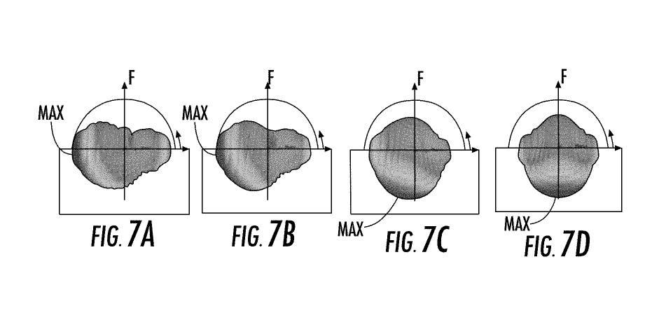

Regardless of the particular configuration for first parasitic element 204 and second parasitic element 206, by tuning the impedances of the first impedance element 214 and the second impedance element 216 to be highly reflective or reactive, a signal beam at the active antenna element 202 can be effectively steered as discussed above. FIGS. 7A-7D illustrate one example of steering the beam with different impedances of the first impedance element 214 and the second impedance element 216. In the illustrated embodiment, the beam, the primary lobe of which has a maximum magnitude generally designated MAX, is steerable from 0 degrees to −90 degrees. The radiation pattern plot in FIG. 7A illustrates the beam radiation pattern of the active antenna element 202 when the first effective length l1 is 5 mm and the second effective length l2 is 7.5 mm. As illustrated in FIG. 7A, the radiation pattern plot shows the beam MAX at 0 degrees (left). As the values of the first effective length l1 and the second effective length l2 are altered (for example without limitation, by adjusting the first effective length l1 from 5 mm to 6.3 mm and adjusting the second effective length l2 from 7.5 mm to 6.3 mm), the beam maximum MAX can scan from 0 degrees to −90 degrees as well.

In some embodiments, the different values to which the first effective length l1 and the second effective length l2 can be adjusted can be equal to 5 mm, 6.3 mm, 7 mm, 7.3 mm and 7.5 mm. FIG. 7B illustrates the beam radiation pattern of the active antenna element 202 when the first effective length l1 is 5 mm and the second effective length l2 is 7.3 mm. As illustrated in FIG. 7B, the beam maximum MAX has been steered slightly to between 0 degrees and −90 degrees, but still closer to 0 degrees than 90 degrees. FIG. 7C illustrates the beam radiation pattern of the active antenna element 202 when the first effective length l1 is 6.3 mm and the second effective length l2 is 7 mm. As illustrated in FIG. 7C, the beam maximum MAX has been steered closer to −90 degrees. FIG. 7D illustrates the beam radiation pattern of the active antenna element 202 when the first effective length l1 is 6.3 mm and the second effective length l2 is 6.3 mm. As illustrated in FIG. 7D, the beam maximum MAX has been steered to −90 degrees (down). In some embodiments, for example without limitation, a second array is provided on the opposing side of the ground plane. In this configuration, the beams of two arrays can cover all the directions in the horizontal plane (i.e., 360 degrees).

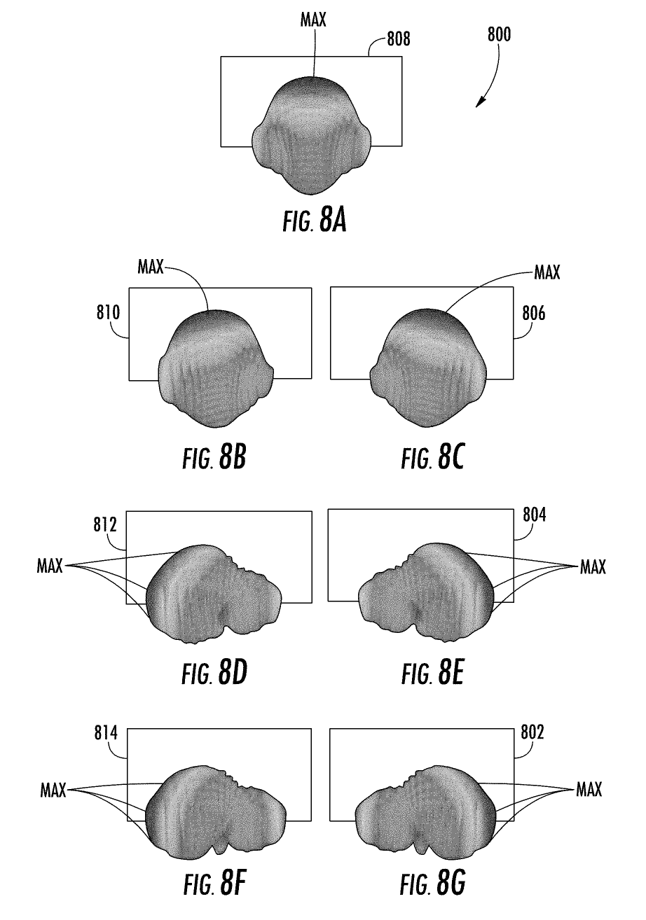

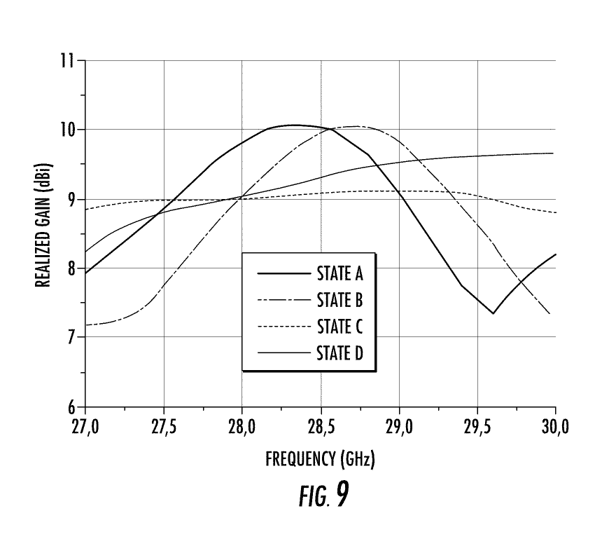

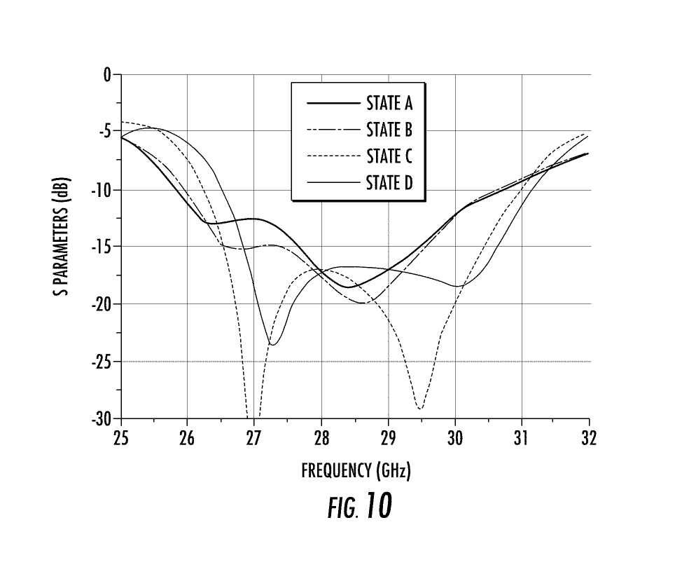

A further example of steering the beam is illustrated in the radiation pattern plots 800 of FIGS. 8A-8G. As described in FIGS. 8A-8G, as the lengths of the transmission lines are altered, the radiation pattern or beam of the antenna system 102 is steered. As the lengths of the transmission lines are changed, so too is the impedance between the parasitic elements and ground. FIG. 8G illustrates a “State A” 802 at which the first effective length l1 is 5 mm and the second effective length l2 is 7.5 mm. In this “State A” 802 configuration, the beam maximum MAX faces to the right, or 0 degrees. FIG. 8E illustrates a “State B” 804 at which the first effective length l1 is 6.3 mm and the second effective length l2 is 7.3 mm. In this “State B” 804 configuration, the beam maximum MAX faces slightly up and to the right, or between 0 degrees and 90 degrees, but closer to 0 degrees. FIG. 8C illustrates a “State C” 806 at which the first effective length l1 is 6.3 mm and the second effective length l2 is 7 mm. In this “State C” 806 configuration, the beam maximum MAX faces up and slightly to the right, or between 0 degrees and 90 degrees, but closer to 90 degrees. FIG. 8A illustrates a “State D” 808 at which the first effective length l1 is 6.3 mm and the second effective length l2 is 6.3 mm. In this “State D” 808 configuration, the beam maximum MAX faces up at about 90 degrees.

FIGS. 8B, 8D, and 8G illustrate “State E,” 810 “State F,” 812 and “State G,” 814 respectively, which use the inverse of the settings for State C, State B, and State A as discussed hereinabove. The tendency of the gain variation with different element distances in “State A” 802 (FIG. 8G) and “State D” 808 (FIG. 8A) is very similar to that in “State B” 804 (FIG. 8E) and “State C” 806 (FIG. 8C), respectively. Therefore, only realized gain of the “State A” 802 and “State D” 808 under different array element distances are shown in FIGS. 8A-8G. With the element distance increasing from 3.2 mm to 3.75 mm, the gain of “State A” 802 (or “State B” 804) is smaller, while the gain of “State D” 808 (or “State C” 806) is higher. A trade-off among the gain of “State A” 802 and “State D” 808 is noticed.

Those of ordinary skill in the art will appreciate that the above described embodiments detail only a few ways in which the essential features of the present disclosure can be implemented. Although the above embodiments achieves the steering capabilities of the system of the present disclosure by using transmission line elements as the impedance elements of the antenna systems, these are not the only components which can be used to alter the impedance between the parasitic elements and ground. It is envisioned that in some embodiments, other methods of tuning the impedance between the parasitic elements and ground can be implemented such that the directionality of the beam of the antenna system 102 can be steered. In some embodiments, for example and without limitation, a manual or automated impedance tuner could be used to tune the impedance between the parasitic elements and ground. Furthermore, in some embodiments, any method which can realize different reactive impedances can be used.

In FIG. 9 and FIG. 10, the realized gain and S parameters with different values for first effective length l1 and second effective length l2 combinations are shown, respectively. As illustrated in FIG. 9, the gain is over 9 dBi in the 28-29 GHz band. As illustrated in FIG. 10, impedance matching for the beam-steerable antenna system 102 is better than −14 dB in the same frequency band.

According to the devices, systems, and methods disclosed above, beam steering can be achieved without the use of phase shifters and/or complicated array feeding networks. There is only one active element. Such devices, systems, and methods can simplify the whole antenna system and generate lower loss than the conventional beam steering configurations. The present subject matter also provides a compact configuration that can be placed at the vacant area of a crowded environment inside mobile terminals. It is also possible, in some embodiments, to integrate an antenna array, a switch, and loaded short (or open) transmission together into a package.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A beam-steerable antenna comprising:
an active antenna element; and
at least one parasitic element spaced apart from the active antenna element;
wherein an impedance between each of the at least one parasitic element and a ground element is tunable to steer a signal beam at the active antenna element in a desired direction.

2. The beam-steerable antenna of claim 1, wherein each of the at least one parasitic element is connected to one or more impedance elements.

3. The beam-steerable antenna of claim 1, wherein the at least one parasitic element comprises:
a first parasitic element; and
a second parasitic element spaced apart from the first parasitic element;
wherein the active antenna element is positioned between the first parasitic element and the second parasitic element; and
wherein a first impedance between the first parasitic element and the ground element and a second impedance between the second parasitic element and the ground element are each independently tunable.

4. The beam-steerable antenna of claim 3, wherein the first parasitic element is connected to a first impedance element, wherein adjusting an impedance of the first impedance element tunes the first impedance between the first parasitic element and the ground element; and
wherein the second parasitic element is connected to a second impedance element, wherein adjusting an impedance of the second impedance element tunes the second impedance between the second parasitic element and the ground element.

5. The beam-steerable antenna of claim 2, wherein one or more of the one or more impedance element comprises at least one transmission line element having a first end that is shorted or open and a second end connected to the at least one parasitic element.

6. The beam-steerable antenna of claim 2, wherein one or more of the one or more impedance element comprises a plurality of transmission line elements having different lengths, wherein each of the plurality of transmission line elements has a first end that is shorted or open and a second end that is selectively connected to the at least one parasitic element by a switch.

7. The beam-steerable antenna of claim 6, wherein the switch comprises one of a MEMS multi-throw switch or a silicon on insulator (SOI) multi-throw switch.

8. The beam-steerable antenna of claim 2, wherein the one or more impedance element comprises one or more tunable element.

9. The beam-steerable antenna of claim 2, wherein the one or more impedance element comprises one or more fixed inductors or one or more fixed capacitors.

10. The beam-steerable antenna of claim 2, wherein the one or more impedance element comprises one or more of a solid-state varactor, an SOI capacitive tuner, a MEMS capacitive tuner, an inductor, or a MEMS impedance tuner.

11. The beam-steerable antenna of claim 1 comprising at least three parasitic elements.

12. A method for steering a signal beam at an antenna element, the method comprising:
positioning the antenna element in proximity to at least one parasitic element;
tuning an impedance between one or more of the at least one parasitic element and a ground element; and
wherein the impedance is tunable to steer the signal beam at the antenna element in a desired direction.

13. The method of claim 12, wherein each of the at least one parasitic elements is connected to one or more impedance elements.

14. The method of claim 12, wherein positioning the antenna element in proximity to at least one parasitic element comprises positioning the antenna element between a first parasitic element and a second parasitic element; and
wherein tuning an impedance between one or more of the at least one parasitic element and a ground element comprises tuning a first impedance between the first parasitic element and the ground element and tuning a second impedance between the second parasitic element and the ground element.

15. The method of claim 12, wherein the first parasitic element is connected to a first impedance element, wherein tuning the first impedance comprises adjusting an impedance between the first impedance element and the ground element; and
wherein the second parasitic element is connected to a second impedance element, wherein tuning the second impedance comprises adjusting an impedance between the second impedance element and the ground element.

16. The method of claim 13, wherein one or more of the one or more impedance element comprises at least one transmission line element having a first end that is shorted or open and a second end connected to the at least one parasitic element.

17. The method of claim 13, wherein one or more of the one or more impedance element comprises a plurality of transmission line elements having different lengths, wherein each of the plurality of transmission line elements has a first end that is shorted or open and a second end that is selectively connected to the at least one parasitic element by a switch;
wherein tuning the first impedance comprises operating the switch to select which of the plurality of transmission line elements is in communication with the at least one parasitic element.

18. The method of claim 17, wherein one or both of the first switch or the second switch comprises one of a MEMS multi-throw switch or a silicon on insulator (SOI) multi-throw switch.

19. The method of claim 13, wherein the one or more impedance element comprises one or more tunable element.

20. The method of claim 13, wherein the one or more impedance element comprises one or more fixed inductors or one or more fixed capacitors.

21. The method of claim 13, wherein one or more of the one or more impedance element comprises one or more of a solid-state varactor, an SOI capacitive tuner, a MEMS capacitive tuner, an inductor, one or more fixed inductors, one or more fixed capacitors, or a MEMS impedance tuner.

22. The method of claim 12 wherein the at least one parasitic element comprises at least three parasitic elements.
